(19) United States
(12) Patent Application Publication
(10) Pub. No.: US 2022/0359109 A1
(43) Pub. Date: Nov. 10, 2022

(54) SOFT MAGNETIC COMPOSITE MATERIAL FOR FLUID FILLING PROCESS

(71) Applicant: Xin KE, Deqing (CN)

(72) Inventor: Xin KE, Deqing (CN)

(21) Appl. No.: 17/623,880

(22) PCT Filed: Mar. 25, 2020
(86) PCT No.: PCT/CN2020/081032

§ 371 Date: Dec. 30, 2021

(30) Foreign Application Priority Data
Jan. 21, 2020 (CN) 2020 10070904.7

(51) Int. Cl. H01F 1/26; B22F 1/16; B22F 1/102; B22F 1/065

(52) U.S. Cl. CPC H01F 1/26; B22F 1/16; B22F 1/102; B22F 1/065

(57) ABSTRACT

The present invention provides a soft magnetic composite material for a fluid filling process, comprising soft magnetic powder and a binder. The soft magnetic powder and the binder are fully mixed, the soft magnetic powder is higher in average Wadell's sphericity, and the soft magnetic powder high in average Wadell's sphericity is small in friction force generated when flowing, small in specific surface area and large in apparent density.

### FIELD OF THE DISCLOSURE

The disclosure relates to a chemical material, in particular to a soft magnetic composite material used in a fluid filling process.

### DESCRIPTION OF RELATED ART

At present, most of the integrated inductors on the market are manufactured by powder metallurgy technology, and are molded through metal powder, so they are also called molded inductors. The specific manufacturing process is as follows: First, the prefabricated hollow coil is placed in the mold, and the metal powder that has been insulated and coated is added, and then it is pressed into a shape, and finally a low-temperature heat curing treatment is performed to obtain an integrated inductor. Compared with other processes, although the powder metallurgy process is relatively simple, but it also has many technical problems.

1. In the pressing process, the metal powder is likely to cause damage to the insulating layer of the hollow coil, resulting in a short circuit, and there is a safety concern, so only relatively low pressure can be used for pressing. Low-pressure suppression will result in low magnetic material density in the inductor, which hinders the inherent characteristics of the material from being fully reflected, and ultimately leads to poor overall performance of the inductor.

2. Since the hollow coil is inside the metal powder, the hollow coil will have a certain elastic change when being pressed, causing delamination between the hollow coil and the magnetic powder. In order to solve this technical problem, the following two methods are mainly used to solve the problem: (1) Metal powder with irregular particle morphology is adopted. During the pressing process of metal powder with irregular shape, the particles can be easily fitted with each other, which facilitates formation of shape; (2) Small particle metal powder is adopted. As compared with large particles, it is relatively easy for the metal powder of small particles to form a shape without delamination, and generally D₅₀ is below 30 μm. Carbon-based iron powder is often adopted in the market, and particles of such powder are very small, generally D₅₀ is about 5 μm. Iron-silicon chrome alloy powder with an irregular shape with D₅₀ around 25 μm is also adopted. In terms of magnetic materials, if the metal powder adopted has spherical or spheroidal particles and belongs to alloy powder, its overall performance is far better than irregular-shaped metal powder. However, it is far more difficult for spherical or spheroidal alloy powder to form shape than irregular-shaped alloy powder. Just as it is difficult for the particles of spherical or spheroidal alloy powder to form into a shape, the current integrated inductors that are manufactured through pressing dry powder of alloy powder adopt finer particles with an irregular shape. Recently, there are also reports about adding a small amount of alloy metal powder with spherical or spheroidal particles to the carbon-based iron powder to manufacture integrated inductors through dry powder pressing to improve performance of products. Because pure iron powder accounts for a relatively high proportion, improvement of overall performance is limited.

3. Generally the powder metallurgy process can only be applied to low-power inductors, and is not possible for preparing high-power integrated inductors. Therefore, the powder metallurgy process cannot meet the market demand for manufacturing medium-sized and large-sized inductors.

In recent years, new fluid filling techniques and methods have been provided in view of the technical problems of the integrally formed inductors prepared by powder metallurgy processes. For example, patent publication no. CN101552091B published a metal powder injection molding inductor and processing method thereof, patent publication no. CN10486760B published a new high-density magnetic composite material for inductors, patent publication no. CN105741997B discloses a composite material of injection-molded plastic and soft magnetic powder and preparation method of composite material, and patent publication no. CN107778847A discloses soft magnetic composite material for integrated injection molded inductor and preparation method thereof. Although many technologies related to the fluid filling process are provided in the patent literature, there is still no related product on the market. At present, the products available on the market are molded inductors formed by dry powder molding using powder metallurgy technology. The cause of such phenomenon lies in that the existing disclosed fluid filling process mainly has the following technical problems.

1. The fluid filling process disclosed in related patents mostly adopts injection molding process. The existing injection molding process provides no limitation to the shape of soft magnetic powder. Because most of the integrated inductors currently produced adopt powder metallurgy process, in order to facilitate molding, irregular metal powder is used most of time. Due to inertial thinking, the existing injection molding process often adopts this type of soft magnetic powder. The irregular soft magnetic powder has poor fluidity. Therefore, in order to meet the needs of the injection process, more binders are often added.

2. In order to increase the fluidity during injection molding, metal powder materials with small particles are used, and generally the particle size is below 30 μm. Theoretically, the metal powder with a single small particle has better fluidity than metal powder with a large particle. However, when multiple metal powder is closely combined, the smaller the metal powder particles, the larger the specific surface area and the smaller the apparent density ratio. Therefore, more binders need to be added to meet the requirements of fluidity.

When the binder is excessively added to the soft magnetic powder, the resulting product will have low magnetic material density. Although the published patents also obtain high-density soft magnetic composite materials through the injection process, in fact, due to the relatively high proportion of the binder, the proportion of non-magnetic substances is also relatively high. Even if the obtained soft magnetic composite material has high density, under the same volume, the actual effective magnetic material ratio is still very low, which leads to poor actual performance of the obtained product.

### SUMMARY OF THE DISCLOSURE

### Technical Problem

In summary, the above technical problems explain why the fluid filling process disclosed in the current patent literature and market does not replace the conventional powder metallurgy process. Based on the technical problems of the fluid filling process disclosed in the conventional technology, the disclosure is dedicated to improve the existing fluid filling process, so that the process can be practically used in the actual production of integrated inductors.

### Solution to Problem

### Technical Solution

The first aspect of the disclosure relates to a soft magnetic composite material used for a fluid filling process, including a soft magnetic powder and a binder, and characterized in that the average Wadell's sphericity of the soft magnetic powder is 75% to 100%, preferably 80% to 100%, more preferably 85% to 100%. The soft magnetic powder that is high in average Wadell's sphericity generates low friction when flowing, and has a small specific surface area and high apparent density. Therefore, under the same fluidity, the soft magnetic composite material containing soft magnetic powder with high average Wadell's sphericity requires less binder than the soft magnetic composite material containing soft magnetic powder with low average Wadell's sphericity. When the fluidity required by a fluid filling process is actually met, the density of the soft magnetic composite material containing the soft magnetic powder with high average Wadell's sphericity is higher, the proportion of the magnetic material is larger, and the effect of the prepared inductor is better. The soft magnetic powder and the binder are fully mixed, which can be either solid soft magnetic powder mixed with a solid binder, or solid soft magnetic powder mixed with a liquid binder.

Preferably, the weight parts of each component of the soft magnetic composite material used in the fluid filling process are as follows.

Soft magnetic powder: 85 to 98 parts, preferably 90 to 96 parts, more preferably 91 to 94 parts.

Binder: 2 to 15 parts, preferably 4 to 10 parts, more preferably 6 to 9 parts.

Preferably, at least a part of the soft magnetic powder is the first type of particles, and the average Wadell's sphericity of the first type of particles is 80% to 100%, preferably 85% to 100%, more preferably 90% to 100%, which accounts for 5% to 100% of the weight of the soft magnetic powder. The higher the average Wadell's sphericity of the soft magnetic powder is when flowing, the generated friction force is smaller, the specific surface area is smaller, and the apparent density is larger. Therefore, when the fluidity is the same, the soft magnetic composite material in which a part of the soft magnetic powder has the first type of spherical or spheroidal particles requires less binder. When the fluidity required by the fluid filling process is actually met, the density of the soft magnetic composite material in which at least a part of the soft magnetic powder has the first type of spherical or spheroidal particle is higher, the proportion of magnetic material is larger, and the effect of the prepared inductor is better.

Preferably, the D₅₀ of the first type of particles is 50 to 110 μm, preferably 70 to 110 μm, more preferably 90 to 110 μm. In a unit volume, the larger the soft magnetic powder particles, the smaller the specific surface area and the larger the bulk ratio. Therefore, the soft magnetic composite material, in which a part of soft magnetic powder is the first type of larger spherical or spheroidal particles, requires less binder to wrap the soft magnetic powder particles to meet the fluidity requirements of the soft magnetic composite material. The density of the soft magnetic composite material is higher, and the magnetic material accounts for a larger proportion.

Preferably, a part of the soft magnetic powder has a second type of particles, and the D₅₀ of the second type of particles is 5 to 40 μm, preferably 5 to 20 μm, and more preferably 5 to 10 μm. Smaller particles of soft magnetic powder can fill the gaps between larger particles of soft magnetic powder, so that the density of the soft magnetic composite material is higher, and the magnetic material accounts for a larger proportion.

Preferably, the average Wadell's sphericity of the second type of particles is 80% to 100%, preferably 85% to 100%, more preferably 90% to 100%. When the soft magnetic powder having smaller particles that can fill the gap between the soft magnetic powder with larger particles has spherical or spheroidal particles, the soft magnetic composite material has better fluidity. When the fluidity required by the fluid filling process is met, the density of the soft magnetic composite material is higher, the proportion of magnetic materials is larger.

Preferably, the ratio of parts by weight of the second type particles to the first type particles is 5 to 30 parts: 70 to 95 parts, preferably 7 to 25 parts: 75 to 93 parts, more preferably 10 to 20 parts: 80 to 90 parts. When the smaller particles of soft magnetic powder filling the gaps between the larger particles of soft magnetic powder are in an appropriate proportion, it can perfectly fill the gaps between the larger particles of soft magnetic powder, so that the density of the soft magnetic composite material is higher, and the proportion of magnetic materials is larger, and it has little effect on the specific surface area of the soft magnetic powder.

Preferably, the soft magnetic composite material used in the fluid filling process further includes a surface insulating agent, and the surface insulating agent is used for insulating and coating the soft magnetic powder, and the parts by weight of each component are as follows.

Soft magnetic powder: 85 to 98 parts, preferably 90 to 96 parts, more preferably 91 to 94 parts.

Binder: 2 to 15 parts, preferably 4 to 10 parts, more preferably 6 to 9 parts.

Surface insulating agent: 0.1 to 2 parts.

Preferably, the soft magnetic powder is a metal powder, preferably alloy powder.

Preferably, the soft magnetic powder is one or more of iron powder, iron silicon aluminum alloy powder, iron silicon alloy powder, iron silicon chromium alloy powder, iron silicon nickel alloy powder, iron silicon aluminum nickel alloy powder, iron nickel alloy powder, iron nickel molybdenum alloy powder, amorphous powder and nanocrystalline powder.

Preferably, the binder is a resin, preferably a thermoplastic resin.

Preferably, the binder is one or more of epoxy resin, phenolic resin, polycarbonate PC, polyamide PA, polyhexamethylene terephthalamide PA6T, polyoxymethylene POM, polyphenylene oxide PPO, polyphenyl ether PPE, polyethylene terephthalate PET, polybutylene terephthalate PBT, polyphenylene sulfide PPS, liquid crystal polymer LCP, polyimide PI, polysulfide PSF, polyaluminum sulfate PAS, polyether ether resin PES, para-aromatic polyamide fiber PPTA, and polyether ether ketone PEEK.

Preferably, the surface insulating agent is one or more of phosphoric acid, chromic acid, aluminum phosphate, nano silicon dioxide, and sodium silicate.

Another aspect of the disclosure relates to a soft magnetic composite particle used for a fluid filling process, including the soft magnetic powder and the binder, and the soft magnetic powder and the binder are mixed and granulated. The soft magnetic powder with high average Wadell's sphericity generates low friction force when flowing, and has a small specific surface area and high apparent density. Therefore, in a hot-melt state and with the same fluidity, the soft magnetic composite particles containing soft magnetic powder with high average Wadell's sphericity require less binder than soft magnetic composite particles containing soft magnetic powder with low average Wadell's sphericity. When the fluidity required by the fluid filling process is actually met, the soft magnetic composite particles containing soft magnetic powder with high average Wadell's sphericity have a higher density, magnetic materials accounts for a larger proportion, and the effect of the prepared inductor is better.

Another aspect of the disclosure relates to a method for preparing a soft magnetic composite material, the method is to fully and uniformly mix the soft magnetic powder and the binder. The mixture can be solid soft magnetic powder mixed with solid binder, or solid soft magnetic powder mixed with liquid binder.

Another aspect of the disclosure relates to the use of the soft magnetic composite material used for a fluid filling process in the preparation of inductors.

Another aspect of the disclosure relates to the use of a soft magnetic composite material used in a fluid filling process in the preparation of a magnetic core.

Another aspect of the disclosure relates to the use of the soft magnetic composite material used for the fluid filling process in the fluid filling process. The fluid filling process is a process that uses fluid to fill a mold and mainly includes injection molding process, casting process, injection transfer molding process, casting molding process, transfer molding process, pressure molding process, and fluid low pressure injection molding process.

Another aspect of the disclosure relates to the use of soft magnetic powder in a fluid filling process. The average Wadell's sphericity of the soft magnetic powder is 75% to 100%, preferably 80% to 100%, and more preferably 85% to 100%. The soft magnetic powder with high average Wadell's sphericity generates low friction force when flowing, and has a small specific surface area and high apparent density. Therefore, under the same fluidity, the soft magnetic composite material containing soft magnetic powder with high average Wadell's sphericity requires less binder than the soft magnetic composite material containing soft magnetic powder with low average Wadell's sphericity. When the fluidity required for the fluid filling process is actually met, the soft magnetic composite material containing the soft magnetic powder with high average Wadell's sphericity has a higher density, the proportion of the magnetic material is larger, and the effect of the prepared inductor is better.

Preferably, at least a part of the soft magnetic powder is the first type of particles, and the average Wadell's sphericity of the first type of particles is 80% to 100%, preferably 85% to 100%, more preferably 90% to 100%, which accounts for 5% to 100% of the weight of the soft magnetic powder. The higher the average Wadell's sphericity of the soft magnetic powder is when flowing, the friction force is smaller, the specific surface area is smaller, and the apparent density is larger. Therefore, when the fluidity is the same, the soft magnetic composite material in which a part of the soft magnetic powder is the first type of spherical or spheroidal particles requires less binder. When the fluidity required by the fluid filling process is actually met, the soft magnetic composite material in which at least a part of the soft magnetic powder is the first type of spherical or spheroidal particles has a higher density, the proportion of magnetic materials is larger, and the effect of the prepared inductor is better.

Preferably, the D₅₀ of the first type of particles is 50 to 110 μm, preferably 70 to 110 μm, more preferably 90 to 110 μm. In a unit volume, the larger the soft magnetic powder particles, the smaller the specific surface area and the larger the bulk ratio. Therefore, the soft magnetic composite material, in which a part of soft magnetic powder is the first type of larger spherical or spheroidal particles, requires less binder to wrap the soft magnetic powder particles to meet the fluidity requirements of the soft magnetic composite material. The density of the soft magnetic composite material is higher, and the magnetic material accounts for a larger proportion.

Preferably, a part of the soft magnetic powder is a second type of particles, and the D₅₀ of the second type of particles is 5 to 40 μm, preferably 5 to 20 μm, and more preferably 5 to 10 μm. Smaller particles of soft magnetic powder can fill the gaps between larger particles of soft magnetic powder, so that the density of the soft magnetic composite material is higher, and the magnetic material accounts for a larger proportion.

Preferably, the average Wadell's sphericity of the second type of particles is 80% to 100%, preferably 85% to 100%, more preferably 90% to 100%. When the soft magnetic powder having smaller particles that can fill the gap between the soft magnetic powder with larger particles has spherical or spheroidal particles, the soft magnetic composite material has better fluidity. When the fluidity required by the fluid filling process is met, the density of the soft magnetic composite material is higher, the proportion of magnetic materials is larger.

Preferably, the ratio of parts by weight of the second type of particles to the first type of particles is 5 to 30 parts: 70 to 95 parts, preferably 7 to 25 parts: 75 to 93 parts, more preferably 10 to 20 parts: 80 to 90 parts. When the smaller particles of soft magnetic powder filling the gaps between the larger particles of soft magnetic powder are in an appropriate proportion, it can perfectly fill the gaps between the larger particles of soft magnetic powder, so that the density of the soft magnetic composite material is higher, and the proportion of magnetic materials is larger, and it has little effect on the specific surface area of the soft magnetic powder.

### Advantageous Effects of the Disclosure

### Advantageous Effects

The advantageous effect of the disclosure is to provide a soft magnetic composite material for fluid filling process with a higher average Wadell's sphericity of soft magnetic powder. In order to achieve better technical effects, soft magnetic powder with smaller particles are filled in soft magnetic powder with larger particles, so that the soft magnetic composite material used in the fluid filling process has better fluidity. In this manner, when the fluidity required by the fluid filling process is satisfied, the soft magnetic composite material used in the fluid filling process has a higher density, the magnetic material has a larger proportion, and the effect of the prepared inductor is better.

### BRIEF DESCRIPTION OF THE DRAWINGS

### Description of the Drawings

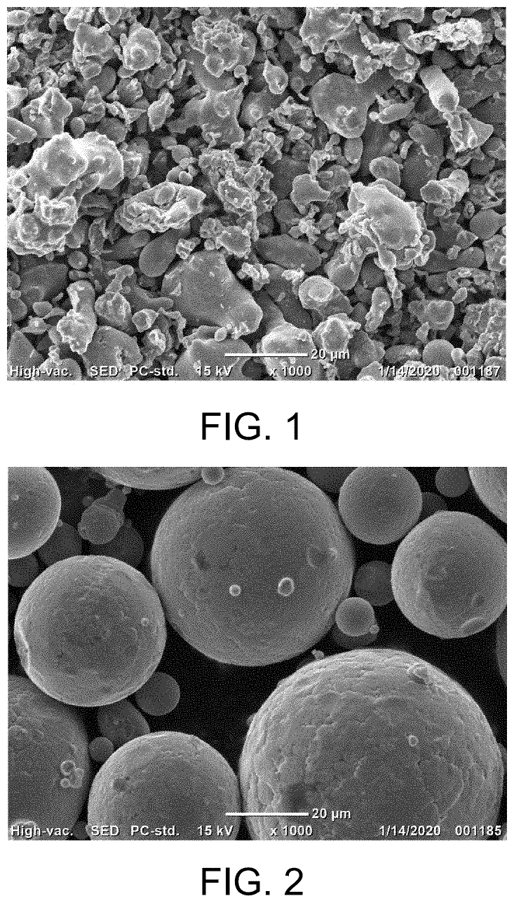

FIG. 1 is a scanning electron micrograph of soft magnetic powder used in the existing injection molding process of control group 1.

FIG. 2 is a scanning electron micrograph of soft magnetic powder with larger spherical or spheroidal particles in group 6.

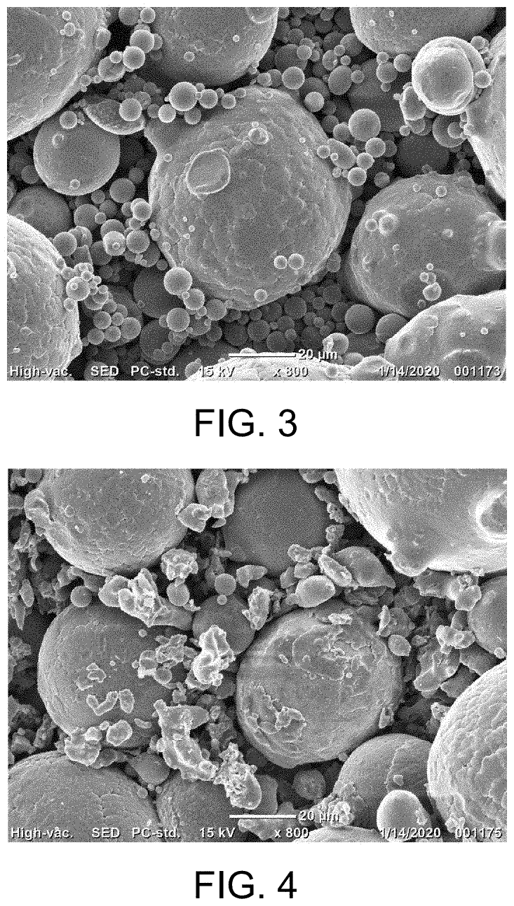

FIG. 3 is a scanning electron micrograph of soft magnetic powder with larger spherical or spheroidal particles added with soft magnetic powder with smaller spherical or spheroidal particles in group 8.

FIG. 4 is a scanning electron micrograph of soft magnetic powder with large spherical or spheroidal particles added with soft magnetic powder with relatively large particles and relatively poor sphericity in group 11.

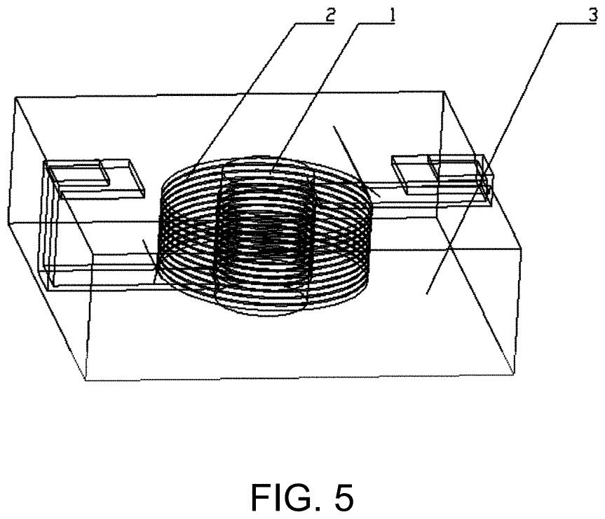

FIG. 5 is a structure diagram of an integrated inductor.

### DESCRIPTION OF EMBODIMENTS

### EMBODIMENTS OF THE INVENTION

Various aspects of the disclosure will be described in detail below, but the disclosure is not limited to these specific embodiments. Those skilled in the art can make some modifications and adjustments to the disclosure based on the essence of the following disclosure, and these adjustments also belong to the scope of the disclosure.

After extensive and in-depth research, the inventor has developed a soft magnetic composite material for fluid filling technology. The soft magnetic composite material has good fluidity. Therefore, when the fluidity required by the fluid filling process is met, the density of soft magnetic composite material used for the fluid filling process is higher, the proportion of magnetic material is larger, and the effect of the prepared inductor is better.

The inventor first compared the specific surface area and bulk density of different types of soft magnetic powders. Different types of soft magnetic powders are available on the market, or another type of soft magnetic powder can be obtained by mixing two types of soft magnetic powders. Then, the inventors respectively took the different types of soft magnetic powders of the same quality and added a binder with the same quality to prepare soft magnetic composite materials, and compared the flow lengths of the different types of soft magnetic composite materials. In the end, the inventor determined the optimal experimental conditions for soft magnetic composite materials based on the above experimental data. On basis of the above, the inventor chose injection molding process, transfer molding process, fluid low pressure injection molding process to manufacture inductors. Inductors were prepared under the optimal experimental conditions of the soft magnetic composite material determined by the disclosure and the experimental conditions of the soft magnetic composite material in the existing fluid filling process, the fluidity of the soft magnetic composite material of the same process is kept consistent, and the equipment conditions are kept consistent. The density of the external magnets, the proportion of magnetic materials, and the initial permeability of the external magnet are measured separately and compared.

### Comparison of Properties of Soft Magnetic Powder

The types of soft magnetic powder in the conventional technology include iron powder, iron silicon aluminum alloy powder, iron silicon alloy powder, iron silicon chromium alloy powder, iron silicon nickel alloy powder, iron silicon aluminum nickel alloy powder, iron nickel alloy powder, iron nickel molybdenum alloy powder, amorphous powder and nanocrystalline powder. The inventor chose the iron silicon chromium alloy powder commonly used for experiment, and the iron silicon chromium alloy powder having irregular particles and with an average Wadell's sphericity of 65.5% in the existing injection molding process is used as the control group. The specific surface area and apparent density of spherical or spheroidal iron silicon chromium alloy powder with an average Wadell's sphericity of 75.2%, 82.1%, and 94.1% were measured respectively. The median diameter D₅₀ of the iron silicon chromium alloy powder in this set of experiments is a smaller particle size commonly adopted in the existing fluid filling process, and D₅₀ is about 17 μm.

Table 1 is the comparison of the properties of iron silicon chromium alloy powder with different average Wadell's sphericity.

TABLE 1

| | Average | Median | Specific | Apparent |
|---|---|---|---|---|
| | Wadell's | diameter | surface area | density |
| Groups | sphericity (%) | D₅₀ (μm) | (m²/g) | (g/cc) |
| Control group 1 | 65.5 | 17.2 | 0.674 | 3.20 |
| Group 1 | 75.2 | 17.4 | 0.546 | 3.31 |
| Group 2 | 82.1 | 17.1 | 0.383 | 3.36 |
| Group 3 | 94.1 | 16.8 | 0.060 | 3.59 |

According to Table 1, it can be seen from the experimental results that, when the D₅₀ remains unchanged, the higher the average Wadell's sphericity of the soft magnetic powder, the smaller the specific surface area of the soft magnetic powder, and the greater the apparent density. Therefore, less binder is required to wrap the soft magnetic powder particles to meet the fluidity requirements of the soft magnetic composite material. Under the same fluidity, the higher the average Wadell's sphericity of the soft magnetic powder contained in the soft magnetic composite material, the higher the density of the soft magnetic composite material, and the larger the proportion of magnetic material.

Then, the inventors used the iron silicon chromium alloy powder with D₅₀ of 5.8 μm as the control group to measure the specific surface area and apparent density of the spherical or spheroidal iron silicon chromium alloy powder with large particles with D₅₀ of 16.8 μm, 50.0 μm, 80.7 μm, and 109.2 μm. The average Wadell's sphericity of the iron silicon chromium alloy powder in this set of experiments is about 94%, which is the average Wadell's sphericity of those with the best effect in the previous set of experiments.

Table 2 shows the comparison of the properties of iron silicon chromium alloy powder with different median diameters D₅₀.

TABLE 2

| | Average | Median | Specific | Apparent |
|---|---|---|---|---|
| | Wadell's | diameter | surface area | density |
| Groups | sphericity (%) | D₅₀ (μm) | (m²/g) | (g/cc) |
| Control group 2 | 94.5 | 5.8 | 0.151 | 2.96 |
| Group 3 | 94.1 | 16.8 | 0.060 | 3.59 |
| Group 4 | 94.5 | 50.0 | 0.032 | 4.21 |
| Group 5 | 93.8 | 80.7 | 0.015 | 4.30 |
| Group 6 | 93.7 | 109.2 | 0.011 | 4.33 |

According to Table 2, it can be seen from the experimental results that when the average Wadell's sphericity of the soft magnetic powder is about 94%, the larger the D₅₀ of the soft magnetic powder, the smaller the specific surface area of the soft magnetic powder and the greater the apparent density. Therefore, less binder is required to wrap the soft magnetic powder particles to meet the fluidity requirements of the soft magnetic composite material. Under the same fluidity, the soft magnetic powder contained in the soft magnetic composite material has a larger D₅₀, the density of the soft magnetic composite material is larger, and the proportion of magnetic materials is higher.

Then, the inventor used the group 6 with the best effect in the above set of experiments as the control group. The soft magnetic powder in group 6 of different parts and the soft magnetic powder in control group 2 of different parts were mixed to prepare soft magnetic powder with larger spherical or spheroidal particles added with smaller spherical or spheroidal particles, and its specific surface area and apparent density were measured.

Table 3 is the comparison of the properties of iron silicon chromium alloy powder with the same composition and different proportions

TABLE 3

| | | | Specific | Apparent |
|---|---|---|---|---|
| | Parts of | Parts of | surface area | density |
| Groups | group 6 | group 2 | (m²/g) | (g/cc) |
| Group 6 | 100 | 0 | 0.011 | 4.33 |
| Group 7 | 95 | 5 | 0.012 | 4.48 |
| Group 8 | 90 | 10 | 0.013 | 4.53 |
| Group 9 | 80 | 20 | 0.016 | 4.49 |
| Group 10 | 70 | 30 | 0.031 | 4.42 |

According to Table 3, it can be seen from the experimental results that adding a small amount of soft magnetic powder with smaller spherical or spheroidal particles to the soft magnetic powder with larger spherical or spheroidal particles makes no great change to the specific surface area of the soft magnetic powder, but the apparent density of the soft magnetic powder is increased. The soft magnetic powder with smaller spherical or spheroidal particles fills the gaps of the soft magnetic powder with larger spherical or spheroidal particles, so that the prepared soft magnetic composite material has a greater density and a larger proportion of magnetic materials.

Finally, the inventor used the group 8 with the best effect in the above set of experiments as the control group. The 10 parts of soft magnetic powder of the control group 2 in the group 8 are replaced with the same parts of soft magnetic powder of group 1. The spherical or spheroidal soft magnetic powder with larger particles was prepared by adding powder with relatively large particles and relatively poor sphericity, and its specific surface area and apparent density were measured.

Table 4 shows the comparison of the properties of iron silicon chromium alloy powder with different compositions and the same proportions.

TABLE 4

| | | | | Specific | Apparent |
|---|---|---|---|---|---|
| | Parts of | Parts of | Parts of | surface area | density |
| Groups | group 6 | group 2 | group 1 | (m²/g) | (g/cc) |
| Group 8 | 90 | 10 | — | 0.013 | 4.53 |
| Group 11 | 90 | — | 10 | 0.038 | 4.40 |

According to Table 4, it can be seen from the experimental results that when the spherical or spheroidal soft magnetic powder with larger particles was added with spherical or spheroidal soft magnetic powder with smaller particles, its D₅₀ became larger and the average Wadell's sphericity became lower, the specific surface area of the soft magnetic powder was significantly increased, and the apparent density was slightly reduced. However, compared to the specific surface area and apparent density of the control group 1 used in the existing injection molding process, the disclosure still has great advantages.

The scanning electron micrograph of the soft magnetic powder of the control group 1 is shown in FIG. 1, the scanning electron micrograph of the soft magnetic powder of the group 6 is shown in FIG. 2, the scanning electron micrograph of the soft magnetic powder of the group 8 is shown in FIG. 3, and the scanning electron micrograph of the soft magnetic powder of the group 11 is shown in FIG. 4.

Average Wadell's sphericity measurement method: 20 g of sample powder is taken, a vacuum dispersion method is used, the powder is dispersed directly on the sample test glass plate, and then the powder is measured through the zoom microscopic imaging scanning technology; test instrument: Ouqi Austrian OCCHIO-500 nano image particle shape analyzer.

Specific surface area measurement method: vacuum volume method is used, 10 g of sample powder is placed into the test tube for measurement; test instrument: NOVATOUCH specific surface area and pore size analyzer.

Apparent density measurement method: Funnel method measurement is adopted, 50 g of soft magnetic powder is taken and poured evenly into the container through the funnel, part of the powder that is higher than the mouth of the container is scraped off with a blade, and the weight of the powder after loading is measured, thereby calculating the weight of the powder per unit volume; measurement instrument: fluidity and apparent density test device.

### Comparison of the Fluidity of Soft Magnetic Composite Materials

Types of binders in the conventional technology include epoxy resin, phenolic resin, polycarbonate PC, polyamide PA, polyhexamethylene terephthalamide PA6T, polyoxymethylene POM, polyphenylene oxide PPO, polyphenyl ether PPE, polyethylene terephthalate PET, polybutylene terephthalate PBT, polyphenylene sulfide PPS, liquid crystal polymer LCP, polyimide PI, polysulfide PSF, polyaluminum sulfate PAS, polyether ether resin PES, para-aromatic polyamide fiber PPTA, and polyether ether ketone PEEK. The inventor selected PA6T, which is commonly used, as the binder, took 9.0 kg of soft magnetic powder from each of the above groups, and added 1.0 kg of binder to prepare a soft magnetic composite material, and then tested the fluidity of the soft magnetic composite material and expressed it in terms of flow length.

Table 5 shows comparison of the flow length of different groups of soft magnetic composite materials

TABLE 5

| Groups | Flow length (cm) |
|---|---|
| Control group 1 | 17.8 |
| Group 1 | 18.6 |
| Group 2 | 19.4 |
| Group 3 | 37.5 |
| Control group 2 | 37.7 |
| Group 4 | 38.2 |
| Group 5 | 38.9 |
| Group 6 | 39.3 |
| Group 7 | 39.0 |
| Group 8 | 39.2 |
| Group 9 | 39.0 |
| Group 10 | 38.0 |
| Group 11 | 37.7 |

According to Tables 1, 2, 3, 4, and 5, it can be seen from the experimental results that the flow length of the soft magnetic composite material is negatively correlated with the specific surface area of the soft magnetic powder, and positively correlated with the apparent density of the soft magnetic powder. The smaller the specific surface area of the soft magnetic powder, the greater the apparent density, and the better the fluidity of the soft magnetic composite material prepared. Therefore, group 8 is the best type of soft magnetic powder. The average Wadell's sphericity of the soft magnetic powder in this group is the highest, and the D₅₀ of the soft magnetic powder with larger particles is the largest, and 10 parts of spherical or spheroidal soft magnetic powder with smaller particles are added to the 90 parts of soft magnetic powder with larger particles.

Flow length test method: The fluidity of the soft magnetic composite material is determined by the flow length under certain injection molding conditions. The soft magnetic composite material is mixed and granulated by a twin-screw extruder to prepare soft magnetic composite particles, and 1.0 kg of soft magnetic composite particles are added to the tube of the injection equipment. The tube temperature is set to 330° C., the prefabricated soft magnetic composite particles are heat-melted into fluid feed, and the screw is rotated to inject the fluid feed into the mold cavity. The injection time is 1 s, and then the length of the sample is measured. The longer the length of the sample, the better the fluidity. The injection equipment parameters; mold temperature 120° C., injection pressure 9 Mpa, injection speed 70 mm/s; mold cavity size: width 10 mm, thickness 2 mm.

The inventors performed the following examples on the basis of the optimal experimental conditions.

### Comparative Example 1

The prefabricated hollow coil was placed into the soft magnetic core, then put into the mold cavity of the injection mold, and finally the mold was closed. 8.7 kg of iron silicon chromium alloy powder was taken, the average Wadell's sphericity of the iron silicon chromium alloy powder is 68.5%, and its median particle size D₅₀ is 45.2 μm. The surface of the iron silicon chromium alloy powder was insulated and coated with phosphoric acid. Then 1.3 kg of PA6T material was selected and mixed with the pre-treated iron silicon chromium alloy powder to prepare the soft magnetic composite material. The soft magnetic composite material was mixed and granulated by a twin-screw extruder, so that each powder particle was uniformly coated with a layer of PA6T material to obtain soft magnetic composite particles. The prepared soft magnetic composite particles were injected into the mold cavity of the mold through injection molding equipment until the mold cavity was completely filled with the soft magnetic composite particles. The flow length of the soft magnetic composite material is 26.2 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 4.32 g/cc, the proportion of magnetic material can reach 87%, and the initial permeability of the outer magnet can reach 9.9μ.

### Embodiment 1

The prefabricated hollow coil was placed into the soft magnetic core, then put into the mold cavity of the injection mold, and finally the mold was closed. 9.2 kg of iron silicon chromium alloy powder was taken. The iron silicon chromium alloy powder consists of 90 parts of iron silicon chromium alloy powder with average Wadell's sphericity of 94.0% and median particle size D₅₀ of 109.2 μm as well as 10 parts of iron silicon chromium alloy powder with average Wadell's sphericity of 94.5% and median particle size D₅₀ of 5.8 μm. The surface of the iron silicon chromium alloy powder was insulated and coated with phosphoric acid. Then 0.8 kg of PA6T material was selected and mixed with the pre-treated iron silicon chromium alloy powder to prepare the soft magnetic composite material. The soft magnetic composite material was mixed and granulated by a twin-screw extruder, so that each powder particle was uniformly coated with a layer of PA6T material to obtain soft magnetic composite particles. The prepared soft magnetic composite particles were injected into the mold cavity of the mold through injection molding equipment until the mold cavity was completely filled with the soft magnetic composite particles. The flow length of the soft magnetic composite material is 26.1 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 5.59 g/cc, the proportion of magnetic material can reach 92%, and the initial permeability of the outer magnet can reach 21.1μ.

Table 6 is the comparison of the properties of the outer magnets formed in Comparative Example 1 and Embodiment 1.

TABLE 6

| | | Proportion of | |
|---|---|---|---|
| | Density | magnetic material | Initial permeability |
| Embodiment | (g/cc) | (%) | of outer magnet (μ) |
| Comparative | 4.32 | 87 | 9.9 |
| Example 1 | | | |
| Embodiment 1 | 5.59 | 92 | 21.1 |

As shown in Table 6, the inductor made of the soft magnetic composite material provided in Embodiment 1 of the disclosure has a higher outer magnetic material density and a larger proportion of the magnetic material than the inductor made of the soft magnetic composite material in Comparative Example 1 of the conventional technology. The initial permeability of the outer magnet increases significantly.

### Comparative Example 2

The prefabricated hollow coil was placed into the soft magnetic core, then put into the mold cavity of the injection mold, and finally the mold was closed. 8.7 kg of iron silicon chromium alloy powder was taken. The iron silicon chromium alloy powder has an average Wadell's sphericity of 63.3% and a median particle size D₅₀ of 50.8 μm. The surface of the iron silicon chromium alloy powder was insulated and coated with phosphoric acid. Then 1.3 kg of PA6T material was selected and mixed with the pre-treated iron silicon chromium alloy powder to prepare the soft magnetic composite material. The soft magnetic composite material was mixed and granulated by a twin-screw extruder, so that each powder particle was uniformly coated with a layer of PA6T material to obtain soft magnetic composite particles. The prepared soft magnetic composite particles were injected into the mold cavity of the mold through injection molding equipment until the mold cavity was completely filled with the soft magnetic composite particles. The flow length of the soft magnetic composite material is 25.9 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 4.21 g/cc, the proportion of magnetic material can reach 87%, and the initial permeability of the outer magnet can reach 10.4μ.

### Embodiment 2

The prefabricated hollow coil was placed into the soft magnetic core, then put into the mold cavity of the injection mold, and finally the mold was closed. 9.2 kg of iron silicon chromium alloy powder was taken. The iron silicon chromium alloy powder consists of 90 parts of iron silicon chromium alloy powder with average Wadell's sphericity of 92.0% and median particle size D₅₀ of 103.6 μm as well as 10 parts of iron silicon chromium alloy powder with average Wadell's sphericity of 91.4% and median particle size D₅₀ of 5.2 μm. The surface of the iron silicon chromium alloy powder was insulated and coated with phosphoric acid. Then 0.8 kg of PA6T material was selected and mixed with the pre-treated iron silicon chromium alloy powder to prepare the soft magnetic composite material. The soft magnetic composite material was mixed and granulated by a twin-screw extruder, so that each powder particle was uniformly coated with a layer of PA6T material to obtain soft magnetic composite particles. The prepared soft magnetic composite particles were injected into the mold cavity of the mold through injection molding equipment until the mold cavity was completely filled with the soft magnetic composite particles. The flow length of the soft magnetic composite material is 26.3 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 5.32 g/cc, the proportion of magnetic material can reach 92%, and the initial permeability of the outer magnet can reach 21.6μ.

Table 7 is the comparison of the properties of the outer magnets formed in Comparative Example 2 and Embodiment 2.

TABLE 7

| | | Proportion of | |
|---|---|---|---|
| | Density | magnetic material | Initial permeability |
| Embodiment | (g/cc) | (%) | of outer magnet (μ) |
| Comparative | 4.21 | 87 | 10.4 |
| Example 2 | | | |
| Embodiment 2 | 5.32 | 92 | 21.6 |

As shown in Table 7, the inductor made of the soft magnetic composite material provided in Embodiment 2 of the disclosure has a higher outer magnetic material density and a larger proportion of the magnetic material than the inductor made of the soft magnetic composite material in Comparative Example 2 of the conventional technology. The initial permeability of the outer magnet increases significantly.

### Comparative Example 3

The prefabricated hollow coil was placed into the soft magnetic core, then put into the mold cavity of the injection mold, and finally the mold was closed. 8.7 kg of iron silicon chromium alloy powder was taken. The iron silicon chromium alloy powder has an average Wadell's sphericity of 69.2% and a median particle size D₅₀ of 44.7 μm. The surface of the iron silicon chromium alloy powder was insulated and coated with phosphoric acid. Then 1.3 kg of PA6T material was selected and mixed with the pre-treated iron silicon chromium alloy powder to prepare the soft magnetic composite material. The soft magnetic composite material was mixed and granulated by a twin-screw extruder, so that each powder particle was uniformly coated with a layer of PA6T material to obtain soft magnetic composite particles. The prepared soft magnetic composite particles were injected into the mold cavity of the mold through injection molding equipment until the mold cavity was completely filled with the soft magnetic composite particles. The flow length of the soft magnetic composite material is 26.8 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 4.37 g/cc, the proportion of magnetic material can reach 87%, and the initial permeability of the outer magnet can reach 10.3μ.

### Embodiment 3

The prefabricated hollow coil was placed into the soft magnetic core, then put into the mold cavity of the injection mold, and finally the mold was closed. 9.2 kg of iron silicon chromium alloy powder was taken. The iron silicon chromium alloy powder consists of 90 parts of iron silicon chromium alloy powder with average Wadell's sphericity of 92.6% and median particle size D₅₀ of 107.4 μm as well as 10 parts of iron silicon chromium alloy powder with average Wadell's sphericity of 93.9% and median particle size D₅₀ of 6.1 μm. The surface of the iron silicon chromium alloy powder was insulated and coated with phosphoric acid. Then 0.8 kg of PA6T material was selected and mixed with the pre-treated iron silicon chromium alloy powder to prepare the soft magnetic composite material. The soft magnetic composite material was mixed and granulated by a twin-screw extruder, so that each powder particle was uniformly coated with a layer of PA6T material to obtain soft magnetic composite particles. The prepared soft magnetic composite particles were injected into the mold cavity of the mold through injection molding equipment until the mold cavity was completely filled with the soft magnetic composite particles. The flow length of the soft magnetic composite material is 26.5 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 5.61 g/cc, the proportion of magnetic material can reach 92%, and the initial permeability of the outer magnet can reach 21.2μ.

Table 8 is the comparison of the properties of the outer magnets formed in Comparative Example 3 and Embodiment 3.

TABLE 8

| | | Proportion of | |
|---|---|---|---|
| | Density | magnetic material | Initial permeability |
| Embodiment | (g/cc) | (%) | of outer magnet (μ) |
| Comparative | 4.37 | 87 | 10.3 |
| Example 3 | | | |
| Embodiment 3 | 5.61 | 92 | 21.2 |

As shown in Table 8, the inductor made of the soft magnetic composite material provided in Embodiment 3 of the disclosure has a higher outer magnetic material density and a larger proportion of the magnetic material than the inductor made of the soft magnetic composite material in Comparative Example 3 of the conventional technology. The initial permeability of the outer magnet increases significantly.

### Comparative Example 4

The prefabricated hollow coil was placed into the soft magnetic core, then put into the mold cavity of the injection mold, and finally the mold was closed. 8.8 kg of iron silicon chromium alloy powder was taken. The iron silicon chromium alloy powder has an average Wadell's sphericity of 68.5% and a median particle size D₅₀ of 45.2 μm. The surface of the iron silicon chromium alloy powder was insulated and coated with phosphoric acid. Then 1.2 kg of PA6T material was selected and mixed with the pre-treated iron silicon chromium alloy powder to prepare the soft magnetic composite material. The soft magnetic composite material was mixed and granulated by a twin-screw extruder, so that each powder particle was uniformly coated with a layer of PA6T material to obtain soft magnetic composite particles. The prefabricated soft magnetic composite particles were added into a hot feeding chamber, and the mold was closed so that the soft magnetic composite particles were heated and melted into a fluid state in the feeding chamber. The heat-melted soft magnetic composite material was pressed by a transfer pressure column through transfer molding, and then injected into the mold cavity through a runner system until the mold cavity was completely filled. The flow length of the soft magnetic composite material is 23.3 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 4.42 g/cc, the proportion of magnetic material can reach 88%, and the initial permeability of the outer magnet can reach 10.8μ.

### Embodiment 4

The prefabricated hollow coil was placed into the soft magnetic core, then put into the mold cavity of the injection mold, and finally the mold was closed. 9.3 kg of iron silicon chromium alloy powder was taken. d The iron silicon chromium alloy powder consists of 90 parts of iron silicon chromium alloy powder with average Wadell's sphericity of 94.0% and median particle size D₅₀ of 109.2 μm as well as 10 parts of iron silicon chromium alloy powder with average Wadell's sphericity of 94.5% and median particle size D₅₀ of 5.8 μm. The surface of the iron silicon chromium alloy powder was insulated and coated with phosphoric acid. Then 0.7 kg of PA6T material was selected and mixed with the pre-treated iron silicon chromium alloy powder to prepare the soft magnetic composite material. The soft magnetic composite material was mixed and granulated by a twin-screw extruder, so that each powder particle was uniformly coated with a layer of PA6T material to obtain soft magnetic composite particles. The prefabricated soft magnetic composite particles were added into a hot feeding chamber, and the mold was closed so that the soft magnetic composite particles were heated and melted into a fluid state in the feeding chamber. The heat-melted soft magnetic composite material was pressed by a transfer pressure column through transfer molding, and then injected into the mold cavity through a runner system until the mold cavity was completely filled. The flow length of the soft magnetic composite material is 23.3 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 5.71 g/cc, the proportion of magnetic material can reach 93%, and the initial permeability of the outer magnet can reach 22.7μ.

Table 9 is the comparison of the properties of the outer magnets formed in Comparative Example 4 and Embodiment 4.

TABLE 9

| | | Proportion of | |
|---|---|---|---|
| | Density | magnetic material | Initial permeability |
| Embodiment | (g/cc) | (%) | of outer magnet (μ) |
| Comparative | 4.42 | 88 | 10.8 |
| Example 4 | | | |
| Embodiment 4 | 5.71 | 93 | 22.7 |

As shown in Table 9, the inductor made of the soft magnetic composite material provided in Embodiment 4 of the disclosure has a higher outer magnetic material density and a larger proportion of the magnetic material than the inductor made of the soft magnetic composite material in Comparative Example 4 of the conventional technology. The initial permeability of the outer magnet increases significantly.

### Comparative Example 5

The prefabricated hollow coil was placed into the soft magnetic core, then put into the mold cavity of the injection mold, and finally the mold was closed. 8.8 kg of iron silicon chromium alloy powder was taken. The iron silicon chromium alloy powder has an average Wadell's sphericity of 63.3% and a median particle size D₅₀ of 50.8 μm. The surface of the iron silicon chromium alloy powder was insulated and coated with phosphoric acid. Then 1.2 kg of PA6T material was selected and mixed with the pre-treated iron silicon chromium alloy powder to prepare the soft magnetic composite material. The soft magnetic composite material was mixed and granulated by a twin-screw extruder, so that each powder particle was uniformly coated with a layer of PA6T material to obtain soft magnetic composite particles. The prefabricated soft magnetic composite particles were added into a hot feeding chamber, and the mold was closed so that the soft magnetic composite particles were heated and melted into a fluid state in the feeding chamber. The heat-melted soft magnetic composite material was pressed by a transfer pressure column through transfer molding, and then injected into the mold cavity through a runner system until the mold cavity was completely filled. The flow length of the soft magnetic composite material is 22.7 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 4.31 g/cc, the proportion of magnetic material can reach 88%, and the initial permeability of the outer magnet can reach 11.2μ.

### Embodiment 5

The prefabricated hollow coil was placed into the soft magnetic core, then put into the mold cavity of the injection mold, and finally the mold was closed. 9.3 kg of iron silicon chromium alloy powder was taken. The iron silicon chromium alloy powder consists of 90 parts of iron silicon chromium alloy powder with average Wadell's sphericity of 90.2% and median particle size D₅₀ of 103.6 μm as well as 10 parts of iron silicon chromium alloy powder with average Wadell's sphericity of 91.4% and median particle size D₅₀ of 5.2 μm. The surface of the iron silicon chromium alloy powder was insulated and coated with phosphoric acid. Then 0.7 kg of PA6T material was selected and mixed with the pre-treated iron silicon chromium alloy powder to prepare the soft magnetic composite material. The soft magnetic composite material was mixed and granulated by a twin-screw extruder, so that each powder particle was uniformly coated with a layer of PA6T material to obtain soft magnetic composite particles. The prefabricated soft magnetic composite particles were added into a hot feeding chamber, and the mold was closed so that the soft magnetic composite particles were heated and melted into a fluid state in the feeding chamber. The heat-melted soft magnetic composite material was pressed by a transfer pressure column through transfer molding, and then injected into the mold cavity through a runner system until the mold cavity was completely filled. The flow length of the soft magnetic composite material is 23.5 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 5.39 g/cc, the proportion of magnetic material can reach 93%, and the initial permeability of the outer magnet can reach 22.9μ.

Table 10 is the comparison of the properties of the outer magnets formed in Comparative Example 5 and Embodiment 5.

TABLE 10

| | | Proportion of | |
|---|---|---|---|
| | Density | magnetic material | Initial permeability |
| Embodiment | (g/cc) | (%) | of outer magnet (μ) |
| Comparative | 4.31 | 88 | 11.2 |
| Example 5 | | | |
| Embodiment 5 | 5.39 | 93 | 22.9 |

As shown in Table 10, the inductor made of the soft magnetic composite material provided in Embodiment 5 of the disclosure has a higher outer magnetic material density and a larger proportion of the magnetic material than the inductor made of the soft magnetic composite material in Comparative Example 5 of the conventional technology. The initial permeability of the outer magnet increases significantly.

### Comparative Example 6

The prefabricated hollow coil was placed into the soft magnetic core, then put into the mold cavity of the injection mold, and finally the mold was closed. 8.8 kg of iron silicon chromium alloy powder was taken. The iron silicon chromium alloy powder has an average Wadell's sphericity of 69.2% and a median particle size D₅₀ of 44.7 μm. The surface of the iron silicon chromium alloy powder was insulated and coated with phosphoric acid. Then 1.2 kg of PA6T material was selected and mixed with the pre-treated iron silicon chromium alloy powder to prepare the soft magnetic composite material. The soft magnetic composite material was mixed and granulated by a twin-screw extruder, so that each powder particle was uniformly coated with a layer of PA6T material to obtain soft magnetic composite particles. The prefabricated soft magnetic composite particles were added into a hot feeding chamber, and the mold was closed so that the soft magnetic composite particles were heated and melted into a fluid state in the feeding chamber. The heat-melted soft magnetic composite material was pressed by a transfer pressure column through transfer molding, and then injected into the mold cavity through a runner system until the mold cavity was completely filled. The flow length of the soft magnetic composite material is 23.9 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 4.49 g/cc, the proportion of magnetic material can reach 88%, and the initial permeability of the outer magnet can reach 10.9μ.

### Embodiment 6

The prefabricated hollow coil was placed into the soft magnetic core, then put into the mold cavity of the injection mold, and finally the mold was closed. 9.3 kg of iron silicon chromium alloy powder was taken. The iron silicon chromium alloy powder consists of 90 parts of iron silicon chromium alloy powder with average Wadell's sphericity of 92.6% and median particle size D₅₀ of 107.4 μm as well as 10 parts of iron silicon chromium alloy powder with average Wadell's sphericity of 93.9% and median particle size D₅₀ of 6.1 μm. The surface of the iron silicon chromium alloy powder was insulated and coated with phosphoric acid. Then 0.7 kg of PA6T material was selected and mixed with the pre-treated iron silicon chromium alloy powder to prepare the soft magnetic composite material. The soft magnetic composite material was mixed and granulated by a twin-screw extruder, so that each powder particle was uniformly coated with a layer of PA6T material to obtain soft magnetic composite particles. The prefabricated soft magnetic composite particles were added into a hot feeding chamber, and the mold was closed so that the soft magnetic composite particles were heated and melted into a fluid state in the feeding chamber. The heat-melted soft magnetic composite material was pressed by a transfer pressure column through transfer molding, and then injected into the mold cavity through a runner system until the mold cavity was completely filled. The flow length of the soft magnetic composite material is 23.1 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 5.85 g/cc, the proportion of magnetic material can reach 93%, and the initial permeability of the outer magnet can reach 22.8μ.

Table 11 is the comparison of the properties of the outer magnets formed in Comparative Example 6 and Embodiment 6.

TABLE 11

| | | Proportion of | |
|---|---|---|---|
| | Density | magnetic material | Initial permeability |
| Embodiment | (g/cc) | (%) | of outer magnet (μ) |
| Comparative | 4.49 | 88 | 10.9 |
| Example 6 | | | |
| Embodiment 6 | 5.85 | 93 | 22.8 |

As shown in Table 11, the inductor made of the soft magnetic composite material provided in Embodiment 6 of the disclosure has a higher outer magnetic material density and a larger proportion of the magnetic material than the inductor made of the soft magnetic composite material in Comparative Example 6 of the conventional technology. The initial permeability of the outer magnet increases significantly.

### Comparative Example 7

The prefabricated hollow coil was placed into the soft magnetic core, then put into the mold cavity of the injection mold, and finally the mold was closed. 8.0 kg of iron silicon chromium alloy powder was taken. The iron silicon chromium alloy powder has an average Wadell's sphericity of 68.5% and a median particle size D₅₀ of 45.2 μm. The surface of the iron silicon chromium alloy powder was insulated and coated with phosphoric acid. Then 2.0 kg of PA6T material was selected and mixed with the pre-treated iron silicon chromium alloy powder to prepare the soft magnetic composite material. Then the pre-treated soft magnetic composite material was placed into the plastic tank of the sol unit and heated into a fluid state, and injected into the mold cavity of the mold through the low-pressure injection molding equipment until the mold cavity was completely filled. The flow length of the soft magnetic composite material is 55.2 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 3.69 g/cc, the proportion of magnetic material can reach 80%, and the initial permeability of the outer magnet can reach 9.1μ.

### Embodiment 7

The prefabricated hollow coil was placed into the soft magnetic core, then put into the mold cavity of the injection mold, and finally the mold was closed. 8.5 kg of iron silicon chromium alloy powder was taken. The iron silicon chromium alloy powder consists of 90 parts of iron silicon chromium alloy powder with average Wadell's sphericity of 94.0% and median particle size D₅₀ of 109.2 μm as well as 10 parts of iron silicon chromium alloy powder with average Wadell's sphericity of 94.5% and median particle size D₅₀ of 5.8 μm. The surface of the iron silicon chromium alloy powder was insulated and coated with phosphoric acid. Then 1.5 kg of PA6T material was selected and mixed with the pre-treated iron silicon chromium alloy powder to prepare the soft magnetic composite material. Then the pre-treated soft magnetic composite material was placed into the plastic tank of the sol unit and heated into a fluid state, and injected into the mold cavity of the mold through the low-pressure injection molding equipment until the mold cavity was completely filled. The flow length of the soft magnetic composite material is 55.4 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 5.17 g/cc, the proportion of magnetic material can reach 85%, and the initial permeability of the outer magnet can reach 15.4μ.

Table 12 is the comparison of the properties of the outer magnets formed in Comparative Example 7 and Embodiment 7.

TABLE 12

| | | Proportion of | |
|---|---|---|---|
| | Density | magnetic material | Initial permeability |
| Embodiment | (g/cc) | (%) | of outer magnet (μ) |
| Comparative | 3.69 | 80 | 9.1 |
| Example 7 | | | |
| Embodiment 7 | 5.17 | 85 | 15.4 |

As shown in Table 12, the inductor made of the soft magnetic composite material provided in Embodiment 7 of the disclosure has a higher outer magnetic material density and a larger proportion of the magnetic material than the inductor made of the soft magnetic composite material in Comparative Example 7 of the conventional technology. The initial permeability of the outer magnet increases significantly.

### Comparative Example 8

The prefabricated hollow coil was placed into the soft magnetic core, then put into the mold cavity of the injection mold, and finally the mold was closed. 8.0 kg of iron silicon chromium alloy powder was taken. The iron silicon chromium alloy powder has an average Wadell's sphericity of 63.4% and a median particle size D₅₀ of 50.8 μm. The surface of the iron silicon chromium alloy powder was insulated and coated with phosphoric acid. Then 2.0 kg of PA6T material was selected and mixed with the pre-treated iron silicon chromium alloy powder to prepare the soft magnetic composite material. Then the pre-treated soft magnetic composite material was placed into the plastic tank of the sol unit and heated into a fluid state, and injected into the mold cavity of the mold through the low-pressure injection molding equipment until the mold cavity was completely filled. The flow length of the soft magnetic composite material is 55.7 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 3.56 g/cc, the proportion of magnetic material can reach 80%, and the initial permeability of the outer magnet can reach 8.9μ.

### Embodiment 8

The prefabricated hollow coil was placed into the soft magnetic core, then put into the mold cavity of the injection mold, and finally the mold was closed. 8.5 kg of iron silicon chromium alloy powder was taken. The iron silicon chromium alloy powder consists of 90 parts of iron silicon chromium alloy powder with average Wadell's sphericity of 90.2% and median particle size D₅₀ of 103.6 μm as well as 10 parts of iron silicon chromium alloy powder with average Wadell's sphericity of 91.4% and median particle size D₅₀ of 5.2 μm. The surface of the iron silicon chromium alloy powder was insulated and coated with phosphoric acid. Then 1.5 kg of PA6T material was selected and mixed with the pre-treated iron silicon chromium alloy powder to prepare the soft magnetic composite material. Then the pre-treated soft magnetic composite material was placed into the plastic tank of the sol unit and heated into a fluid state, and injected into the mold cavity of the mold through the low-pressure injection molding equipment until the mold cavity was completely filled. The flow length of the soft magnetic composite material is 55.0 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 4.78 g/cc, the proportion of magnetic material can reach 85%, and the initial permeability of the outer magnet can reach 15.6μ.

Table 13 is the comparison of the properties of the outer magnets formed in Comparative Example 8 and Embodiment 8.

TABLE 13

| | | Proportion of | |
|---|---|---|---|
| | Density | magnetic material | Initial permeability |
| Embodiment | (g/cc) | (%) | of outer magnet (μ) |
| Comparative | 3.56 | 80 | 8.9 |
| Example 8 | | | |
| Embodiment 8 | 4.78 | 85 | 15.6 |

As shown in Table 13, the inductor made of the soft magnetic composite material provided in Embodiment 8 of the disclosure has a higher outer magnetic material density and a larger proportion of the magnetic material than the inductor made of the soft magnetic composite material in Comparative Example 8 of the conventional technology. The initial permeability of the outer magnet increases significantly.

### Comparative Example 9

The prefabricated hollow coil was placed into the soft magnetic core, then put into the mold cavity of the injection mold, and finally the mold was closed. 8.0 kg of iron silicon chromium alloy powder was taken. The iron silicon chromium alloy powder has an average Wadell's sphericity of 69.2% and a median particle size D₅₀ of 44.7 μm. The surface of the iron silicon chromium alloy powder was insulated and coated with phosphoric acid. Then 2.0 kg of PA6T material was selected and mixed with the pre-treated iron silicon chromium alloy powder to prepare the soft magnetic composite material. Then the pre-treated soft magnetic composite material was placed into the plastic tank of the sol unit and heated into a fluid state, and injected into the mold cavity of the mold through the low-pressure injection molding equipment until the mold cavity was completely filled. The flow length of the soft magnetic composite material is 55.8 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 3.72 g/cc, the proportion of magnetic material can reach 80%, and the initial permeability of the outer magnet can reach 9.2μ.

### Embodiment 9

The prefabricated hollow coil was placed into the soft magnetic core, then put into the mold cavity of the injection mold, and finally the mold was closed. 8.5 kg of iron silicon chromium alloy powder was taken. The iron silicon chromium alloy powder consists of 90 parts of iron silicon chromium alloy powder with average Wadell's sphericity of 92.6% and median particle size D₅₀ of 107.4 μm as well as 10 parts of iron silicon chromium alloy powder with average Wadell's sphericity of 93.9% and median particle size D₅₀ of 6.1 μm. The surface of the iron silicon chromium alloy powder was insulated and coated with phosphoric acid. Then 1.5 kg of PA6T material was selected and mixed with the pre-treated iron silicon chromium alloy powder to prepare the soft magnetic composite material. Then the pre-treated soft magnetic composite material was placed into the plastic tank of the sol unit and heated into a fluid state, and injected into the mold cavity of the mold through the low-pressure injection molding equipment until the mold cavity was completely filled. The flow length of the soft magnetic composite material is 55.7 cm, and therefore the outside of the coil and the magnetic core were filled with the soft magnetic composite material. After the injected soft magnetic composite material was cured to form an outer magnet, demolding was performed to obtain an integral inductor. The density of the outer magnet material of the inductor can reach 5.21 g/cc, the proportion of magnetic material can reach 85%, and the initial permeability of the outer magnet can reach 15.5μ.

Table 14 is the comparison of the properties of the outer magnets formed in Comparative Example 9 and Embodiment 9.

TABLE 14

| | | Proportion of | |
|---|---|---|---|
| | Density | magnetic material | Initial permeability |
| Embodiment | (g/cc) | (%) | of outer magnet (μ) |
| Comparative | 3.72 | 80 | 9.2 |
| Example 9 | | | |
| Embodiment 9 | 5.21 | 85 | 15.5 |

As shown in Table 14, the inductor made of the soft magnetic composite material provided in Embodiment 9 of the disclosure has a higher outer magnetic material density and a larger proportion of the magnetic material than the inductor made of the soft magnetic composite material in Comparative Example 9 of the conventional technology. The initial permeability of the outer magnet increases significantly.

The measurement method of the density of the outer magnet material of the inductor: the drainage method is adopted, first the weight m1 of the outer magnet is measured, then the weight m2 of the outer magnet in the water is measured, and then the density ρ=m1/(m1-m2) is calculated; test instrument: JA3003J electronic balance.

The measurement method of the proportion of magnetic materials: the proportion of magnetic materials=the weight of the added soft magnetic powder/(the weight of the added soft magnetic powder+the weight of the added binder), and the weight of the surface coating agent is ignored.

The measurement method of the initial permeability of the outer magnet: the LCR tester is used to measure the inductance L@0A, and then the initial permeability of the outer magnet is calculated μ=L@0A*le/(4*π*Ae*N\hat{ }2), le is the effective magnetic circuit length, Ae is the cross-sectional area of effective magnetic core, and N is the number of windings; test instrument: TH2829C LCR tester.

Flow length test method: The fluidity of the soft magnetic composite material is determined by the flow length under certain injection molding conditions. The soft magnetic composite material is mixed and granulated by a twin-screw extruder to prepare soft magnetic composite particles, and 1.0 kg of soft magnetic composite particles are added to the tube of the injection equipment. The tube temperature is set to 330° C., the prefabricated soft magnetic composite particles are heat- melted into fluid feed, and the screw is rotated to inject the fluid feed into the mold cavity. The injection time is 1 s, and then the length of the sample is measured. The longer the length of the sample, the better the fluidity. The injection equipment parameters; mold temperature 120° C., injection pressure 9 Mpa, injection speed 70 mm/s; mold cavity size: width 10 mm, thickness 2 mm.

### Embodiment 10

As shown in FIG. 5, an integrally formed inductor includes a magnetic core 1, a coil 2, and an outer magnet 3. The coil 2 has a hollow structure, the magnetic core 1 is placed inside the coil 2, and the outer magnet wraps the magnetic core 1 and the coil 2. Both ends of the coil 2 extend out of the outer magnet 3, and the outer magnet is formed by curing the soft magnetic composite material of the foregoing embodiments of the disclosure.

1. A soft magnetic composite material used in a fluid filling process, comprising a soft magnetic powder and a binder, characterized in that an average Wadell's sphericity of the soft magnetic powder is 85% to 100%.

2. The soft magnetic composite material used in the fluid filling process according to claim 1, wherein at least a part of the soft magnetic powder is a first type of particles, and an average Wadell's sphericity of the first type of particles is 85% to 100%, the first type of particles accounts for 5% to 100% of a weight of the soft magnetic powder.

3. (canceled)

4. (canceled)

5. (canceled)

6. (canceled)

7. The soft magnetic composite material used in the fluid filling process according to claim 1, comprising a surface insulating agent, and the surface insulating agent is utilized for insulating and coating the soft magnetic powder, and parts by weight of each component are as follows:
the soft magnetic powder: 90 to 96 parts;
the binder: 4 to 10 parts;
the surface insulating agent: 0.1 to 2 parts.

8. (canceled)

9. (canceled)

10. (canceled)

11. (canceled)

12. (canceled)

13. A soft magnetic composite particle used in a fluid filling process, wherein the soft magnetic powder specified in claim 1 and the binder are mixed and granulated.

14. A method for preparing a soft magnetic composite material, comprising a step of fully and uniformly mixing the soft magnetic powder specified in claim 1 and the binder.

15. (canceled)

16. (canceled)

17. (canceled)

18. (canceled)

19. The soft magnetic composite material used in the fluid filling process according to claim 1, wherein at least a part of the soft magnetic powder is a first type of particles, and an average Wadell's sphericity of the first type of particles is 90% to 100%, the first type of particles accounts for 5% to 100% of a weight of the soft magnetic powder.

20. The soft magnetic composite material used in the fluid filling process according to claim 19, wherein a median diameter of the first type of particles is 70 to 110 μm.

21. The soft magnetic composite material used in the fluid filling process according to claim 19, wherein a median diameter of the first type of particles is 90 to 110 μm.

22. The soft magnetic composite material used in the fluid filling process according to claim 21, wherein a part of the soft magnetic powder is a second type of particles, and a median diameter of the second type of particles is 5 to 20 μm.

23. The soft magnetic composite material used in the fluid filling process according to claim 21, wherein a part of the soft magnetic powder is a second type of particles, and a median diameter of the second type of particles is 5 to 10 μm.

24. The soft magnetic composite material used in the fluid filling process according to claim 23, wherein an average Wadell's sphericity of the second type of particles is 85% to 100%.

25. The soft magnetic composite material used in the fluid filling process according to claim 23, wherein an average Wadell's sphericity of the second type of particles is 90% to 100%.

26. The soft magnetic composite material used in the fluid filling process according to claim 25, wherein a ratio of parts of weight of the second type of particles to the first type of particles is 7 to 25 parts: 75 to 93 parts.

27. The soft magnetic composite material used in the fluid filling process according to claim 25, wherein a ratio of parts of weight of the second type of particles to the first type of particles is 10 to 20 parts: 80 to 90 parts.

28. The soft magnetic composite material used in the fluid filling process according to claim 1, comprising a surface insulating agent, and the surface insulating agent is utilized for insulating and coating the soft magnetic powder, and parts by weight of each component are as follows:
the soft magnetic powder: 91 to 94 parts;
the binder: 6 to 9 parts;
the surface insulating agent: 0.1 to 2 parts.

29. The soft magnetic composite material used in the fluid filling process according to claim 28, wherein the soft magnetic powder is alloy powder.

30. The soft magnetic composite material used in the fluid filling process according to claim 28, wherein the soft magnetic powder is one or more of iron powder, iron silicon aluminum alloy powder, iron silicon alloy powder, iron silicon chromium alloy powder, iron silicon nickel alloy powder, iron silicon aluminum nickel alloy powder, iron nickel alloy powder, iron nickel molybdenum alloy powder, amorphous powder and nanocrystalline powder.

31. The soft magnetic composite material used in the fluid filling process according to claim 28, wherein the binder is a resin.

32. The soft magnetic composite material used in the fluid filling process according to claim 28, wherein the binder is one or more of epoxy resin, phenolic resin, polycarbonate, polyamide, polyhexamethylene terephthalamide, polyoxymethylene, polyphenylene oxide, polyphenyl ether, polyethylene terephthalate, polybutylene terephthalate, polyphenylene sulfide, liquid crystal polymer, polyimide, polysulfide, polyaluminum sulfate, polyether ether resin, para-aromatic polyamide fiber, and polyether ether ketone.

33. The soft magnetic composite material used in the fluid filling process according to claim 28, wherein the surface insulating agent is one or more of phosphoric acid, chromic acid, aluminum phosphate, nano silicon dioxide, and sodium silicate.
